(19) United States
(12) Patent Application Publication
(10) Pub. No.: US 2011/0177979 A1
(43) Pub. Date: Jul. 21, 2011

(54) CARTRIDGE FOR CHEMICAL PROCESSING

(75) Inventors: Takeo Tanaami, Tokyo (JP); Hisao Katakura, Tokyo (JP); Katsumori Gyounouchi, Tokyo (JP)

(73) Assignee: YOKOGAWA ELECTRIC CORPORATION, Tokyo (JP)

(21) Appl. No.: 13/009,264

(22) Filed: Jan. 19, 2011

(30) Foreign Application Priority Data
Jan. 19, 2010 (JP) 2010-008717

(51) Int. Cl. C40B 60/00

(52) U.S. Cl. 506/33

(57) ABSTRACT

A cartridge for chemical processing carries out chemical processing while moving a content by deformation based on an externally applied force, and includes a microarray chip housed in the cartridge for chemical processing; a member having a surface that faces a surface of the microarray chip; a supporting unit for supporting the member such that a width of a gap between the member and the microarray chip is variable by the externally applied force; and a limiting unit for restricting a variable range of the gap by the supporting unit such that the width of the entire gap between the surface of the member and the surface of the microarray chip does not become smaller than a predetermined width.

### BACKGROUND OF THE INVENTION

The present application claims priority from Japanese Application 2010-008717, filed on Jan. 19, 2010, the entire contents of which being incorporated herein by reference.

1. Field of the Invention

The present invention relates to a cartridge for chemical processing, the cartridge carrying out chemical processing while moving a content by deformation based on an externally applied force.

2. Description of the Related Art

There has been known a cartridge for chemical processing, the cartridge carrying out chemical processing while moving a content by deformation based on an externally applied force. The cartridge for chemical processing has formed therein wells and channels that are shaped and arranged suitably for the procedure of desirable chemical processing. If the content is moved, for example, by sliding a roller while the roller is pressed against the cartridge, the chemical processing based on the procedure can be easily executed.

Japanese Unexamined Patent Application Publication No. 2004-226068 discloses a cartridge for chemical processing that houses a microarray chip. With this cartridge, hybridization can be performed at the microarray chip by moving a solution with application of an external force. Also, target molecules can be measured by optically measuring the microarray chip from the outside of the cartridge through a window that is formed of a silicone rubber.

However, with the cartridge of related art, bright spots caused by, for example, impurities in the silicone rubber, which is used as the window, disturb the optical measurement. In addition, the silicone rubber is deformed and hence cannot maintain uniformity of the gap between the microarray chip and the window. The flow of effluent after the hybridization is not uniform for the entire microarray chip. In some cases, the silicone rubber may even contact the chip. As the result, the effluent remains uneven, and measurement accuracy is degraded.

### SUMMARY OF THE INVENTION

An object of the present invention is to provide a cartridge for chemical processing that can increase inspection accuracy with a microarray chip.

A cartridge for chemical processing according to an aspect of the present invention carries out chemical processing while moving a content by deformation based on an externally applied force, and includes a microarray chip housed in the cartridge for chemical processing; a member having a surface that faces a surface of the microarray chip; a supporting unit for supporting the member such that a width of a gap between the member and the microarray chip is variable by the externally applied force; and a limiting unit for restricting a variable range of the gap by the supporting unit such that the width of the entire gap between the surface of the member and the surface of the microarray chip does not become smaller than a predetermined width.

With the cartridge for chemical processing, the variable range of the gap is restricted such that the width of the entire gap between the surface of the member and the surface of the microarray chip does not become smaller than a predetermined width. Accordingly, the gap between the surface of the member and the surface of the microarray chip can be properly controlled, and the inspection accuracy with the microarray chip can be increased.

The limiting unit may be provided at the member.

The limiting unit may be formed at the member and serve as a contact portion that contacts the surface of the microarray chip.

Alternatively, the limiting unit may be formed at the microarray chip and serve as a contact portion that contacts the surface of the member.

The gap between the surface of the member and the surface of the microarray chip may be uniform when the gap is restricted by the limiting unit.

The member may be transparent and the surface of the microarray chip may be optically measurable through the member from the outside of the cartridge for chemical processing.

Alternatively, the microarray chip may be transparent and the surface of the microarray chip may be optically measurable through the microarray chip from the outside of the cartridge for chemical processing.

The member may have an extending portion that pushes and eliminates a space in the cartridge for chemical processing in an area surrounding the microarray chip when the member is pressed against the microarray chip.

### BRIEF DESCRIPTION OF THE DRAWINGS

FIGS. 1A and 1B illustrate a configuration of a cartridge for chemical processing according to an embodiment, FIG. 1A being a cross-sectional view showing the configuration of the cartridge for chemical processing, FIG. 1B being a plan view from a direction indicated by line IB-IB in FIG. 1A;

FIGS. 2A and 2B illustrate states during hybridization, FIGS. 2A and 2B being cross-sectional views of cartridges for chemical processing;

FIGS. 3A to 3C illustrate a portion of a cartridge having a member facing a microarray chip, FIG. 3A being a cross-sectional view of a cartridge for chemical processing having a member, FIG. 3B being an enlarged cross-sectional view of the member, FIG. 3C being a cross-sectional view of a cartridge for chemical processing showing a reinforcing method of the member;

FIGS. 4A and 4B illustrate alternative configurations of members, FIG. 4A being a cross-sectional view showing an example in which the member is provided with a bonding portion having a flange-like extending portion, FIG. 4B being a cross-sectional view showing a situation without an extending portion; and

FIGS. 5A and 5B illustrate a cartridge for chemical processing configured to read a microarray chip from a substrate according to another embodiment, FIGS. 5A and 5B being cross-sectional views of the cartridge for chemical processing.

### DESCRIPTION OF THE PREFERRED EMBODIMENTS

Cartridges for chemical processing according to embodiments of the present invention will now be described.

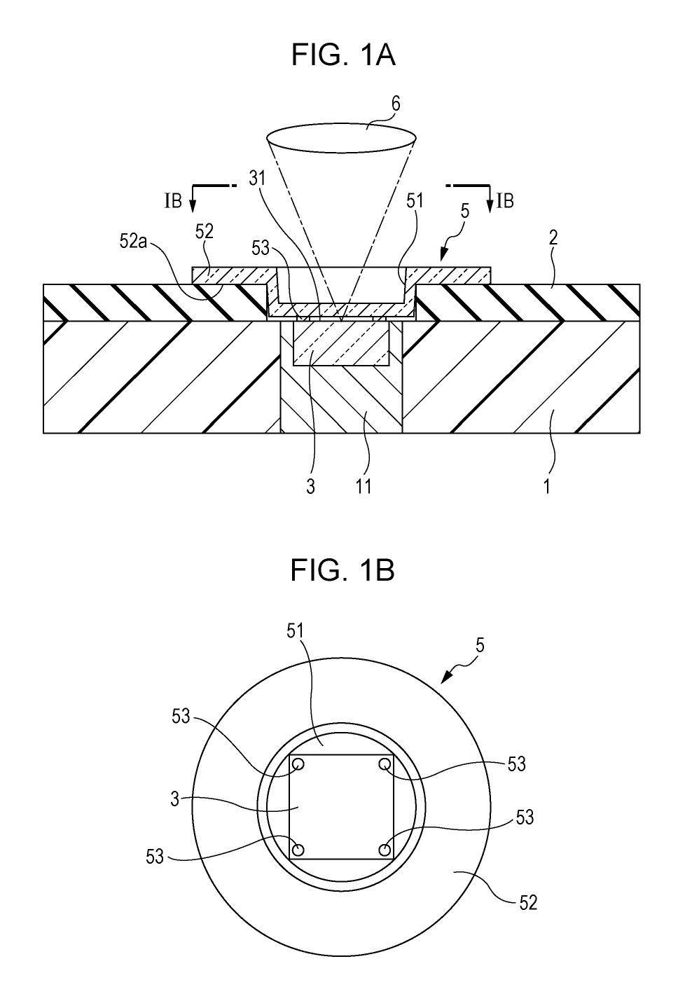

FIG. 1A is a cross-sectional view showing a configuration of a cartridge for chemical processing according to an embodiment. FIG. 1B is a plan view from a direction indicated by line IB-IB in FIG. 1A.

Referring to FIGS. 1A and 1B, the cartridge for chemical processing according to this embodiment includes a substrate 1 made of a relatively hard resin, and a sheet 2 made of a material, such as a silicone rubber, having an airtight property and elasticity. The sheet 2 is stacked on the substrate 1.

The cartridge for chemical processing has formed therein wells (not shown) and channels (not shown) that connect the wells. The wells and channels are arranged and shaped in accordance with the procedure of predetermined chemical processing. The wells and channels are formed as unbonded regions of the substrate 1 and the sheet 2. The substrate 1 and the sheet 2 are bonded to each other in a region surrounding the wells and channels. Accordingly, the inside of the cartridge for chemical processing is hermetic.

When a content is introduced into the cartridge, the sheet 2 is elastically deformed by the pressure of the content. The sheet 2 is separated from the substrate 1 in the region with the well or channel, and hence a gap is defined. The content is sealed in the space of the gap. If the content becomes lost, the shape of the sheet 2 is restored and closely contacts the substrate 1. The desirable chemical processing can be performed while the content in the cartridge is moved from a well to the next well by moving a roller or the like that is pressed against the sheet 2 from the outside (for example, see Japanese Unexamined Patent Application Publication No. 2005-308504).

Referring to FIGS. 1A and 1B, the substrate 1 has a light-shielding region 11 of black color. In addition, a microarray chip 3 is attached to the substrate 1 at a position surrounded by the light-shielding region 11, for inspecting a DNA and a RNA (mRNA, cDNA, and the like), and a biopolymer such as a protein. Sites, to which probes respectively corresponding to target molecules are fixed, are arrayed on a surface 31 of the microarray chip 3. The target molecules are respectively coupled to the sites through hybridization. A fluorescent substance is added to each of the target molecules around the hybridization, so that the target molecules are optically detected by using the fluorescence from the sites.

Referring to FIGS. 1A and 1B, a member 5 made of a hard transparent resin is arranged at a position to face the microarray chip 3. The member 5 is bonded to the sheet 2. In particular, the member 5 is bonded to the sheet 2 with an adhesive polymer interposed therebetween such that the hermeticity of the cartridge for chemical processing is maintained.

The member 5 also has a recess 51 in a center portion and a flange-like bonding portion 52 in a peripheral portion. The member 5 is bonded to the sheet 2 via a bonding surface 52a of the bonding portion 52. Referring to FIG. 1A, the member 5 further has protrusions 53 on a bottom surface. The protrusions 53 determine a gap between the member 5 and the surface 31 of the microarray chip 3. The bottom surface of the member 5 and the surface 31 of the microarray chip 3 are flat. The member 5 is hard enough so that the deformation of the member 5 can be substantially ignored. When the protrusions 53 are in contact with the surface 31 of the microarray chip 3, the gap between the member 5 and the surface 31 of the microarray chip 3 is maintained uniform. For example, the gap is about 20 μm.

The wells, where the hybridization is performed, are provided in the region, to which the microarray chip 3 is attached. The space between the microarray chip 3 and the member 5 is supplied with a hybridization solution through the other wells and channels.

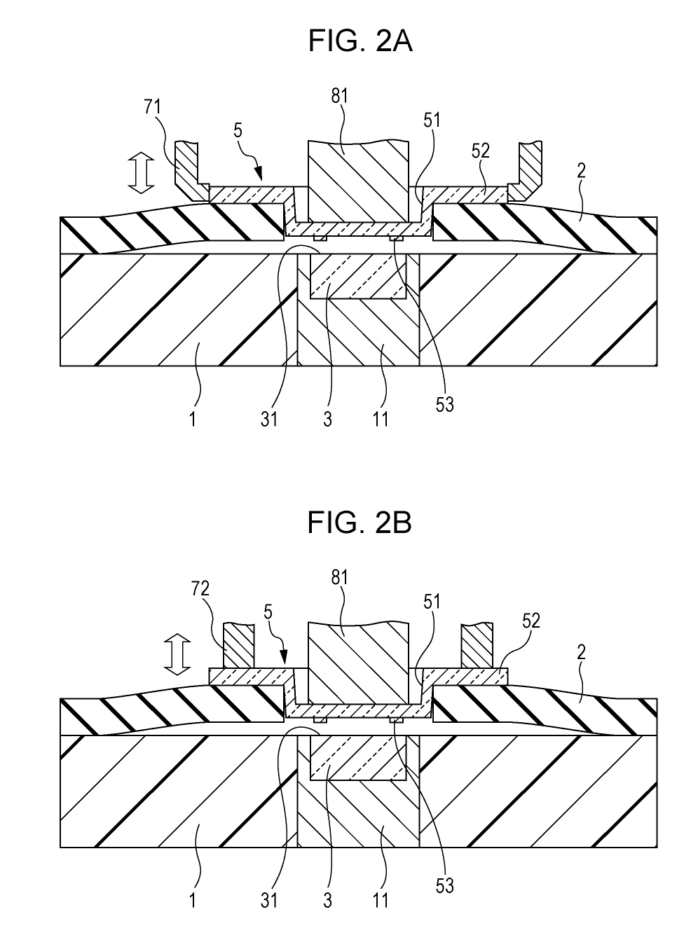

FIGS. 2A and 2B are cross-sectional views showing states during hybridization.

In an example of FIG. 2A, the member 5 is pinched between jigs 71 and mechanically fixed. The member 5 is vibrated by reciprocating the jigs 71 in the vertical direction in FIG. 2A, to stir the hybridization solution or a cleaning solution that is supplied between the microarray chip 3 and the member 5. Also, at this time, the temperature in the cartridge can be controlled by pressing a thermally conductive member 81 against the recess 51 of the member 5. Since the thickness of the member 5 is reduced in the region of the recess 51, the change in temperature by the thermally conductive member 81 can be accelerated.

In an example of FIG. 2B, suction devices 72 are used instead of the jigs 71, to suck and vibrate the member 5 like the example of FIG. 2A. Hybridization can be performed similarly to the example of FIG. 2A.

After the hybridization, referring to FIG. 1A, the microarray chip 3 is irradiated with laser light through an optical system 6 and fluorescence is detected while the protrusions 53 of the member 5 are in contact with the surface 31 of the microarray chip 3. At this time, the member 5 functions as a window that allows the laser light and fluorescence to pass therethrough and to allow the microarray chip 3 to be optically read from the outside of the cartridge. Owing to this, the transparent resin for the member 5 is desirably a material with high-grade optical homogeneity, such as a polycarbonate resin or a polyolefin resin. With the cartridge for chemical processing according to this embodiment, since the optical reading is performed through the member 5, measurement accuracy can be prevented from being degraded due to the sheet 2. Since the member 5 is made of the hard transparent resin and is used as the window, the disadvantage provided if the silicone rubber is used as the window can be avoided.

Also, as described above, with the cartridge for chemical processing according to this embodiment, since the gap between the member 5 and the surface 31 of the microarray chip 3 is maintained uniform, the disadvantage caused by the remaining effluent is not provided, and the highly accurate reading can be performed for the entire microarray chip 3. It is to be noted that the optical reading is performed while the gap between the member 5 and the surface 31 of the microarray chip 3 is filled with the cleaning solution or other predetermined solution.

With the cartridge for chemical processing according to this embodiment, since the light-shielding region 11 reduces background light from a rear surface of the cartridge and scattered light in the cartridge, the measurement accuracy can be increased.

Instead of the protrusions 53 of the member 5, protrusions or spacers, which form a uniform gap between a microarray chip and a member, may be provided at the microarray chip and/or the substrate. This may be an example, in which the protrusions 53 shown in FIG. 1A are not coupled to the member 5 but are coupled to the microarray chip 3.

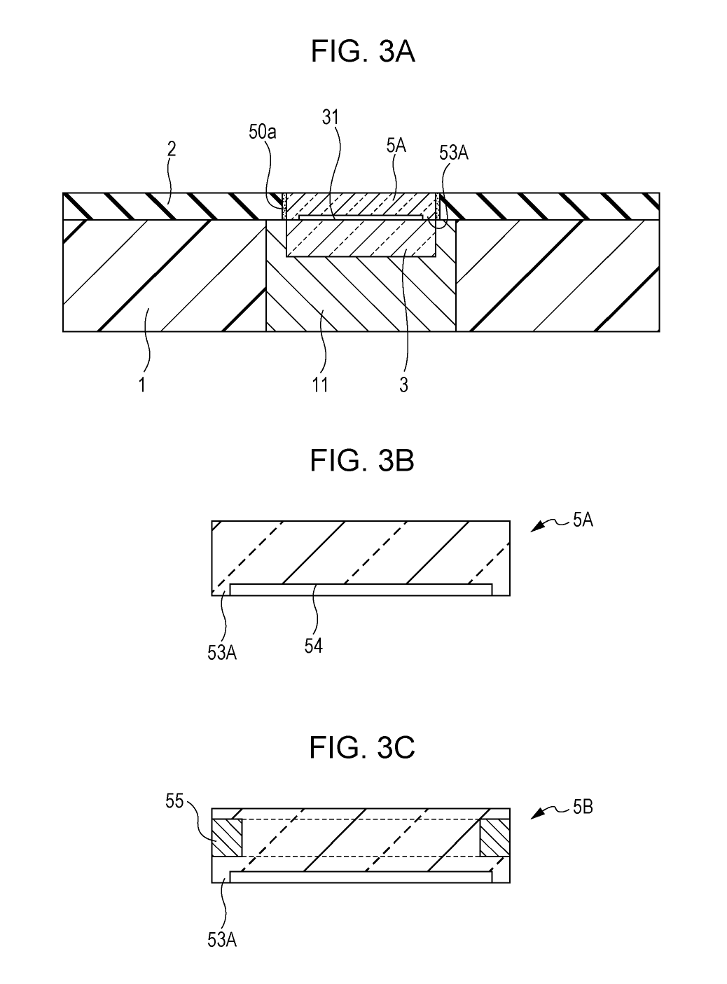

FIGS. 3A to 3C illustrate a portion of a cartridge having a member facing a microarray chip.

FIG. 3A is a cross-sectional view of a cartridge for chemical processing having a member. FIG. 3B is an enlarged cross-sectional view of the member.

Referring to FIGS. 3A and 3B, a member 5A made of a polycarbonate resin has an outer peripheral surface 50a that is bonded to an end surface of the sheet 2. The member 5A has protrusions 53A that provide a uniform gap between the member 5A and the microarray chip 3. When the protrusions 53A are brought into contact with the microarray chip 3, the gap between a bottom surface 54 of the member 5A and the surface 31 of the microarray chip 3 is maintained uniform.

FIG. 3C is a cross-sectional view showing a reinforcing method of a member.

In an example of FIG. 3C, a ring-like reinforcing member 55 with a high rigidity is fitted to an outer peripheral portion of a member 5B. The reinforcing member 55 is formed of a material with a higher rigidity (for example, a metal) than that of a polycarbonate resin. The reinforcing member 55 is integrally molded with the polycarbonate resin when the member 5B is molded. As described above, since the intensity of the member 5B is increased by the reinforcing member 55, uniformity of the gap between the member 5B and the microarray chip 3 can be increased.

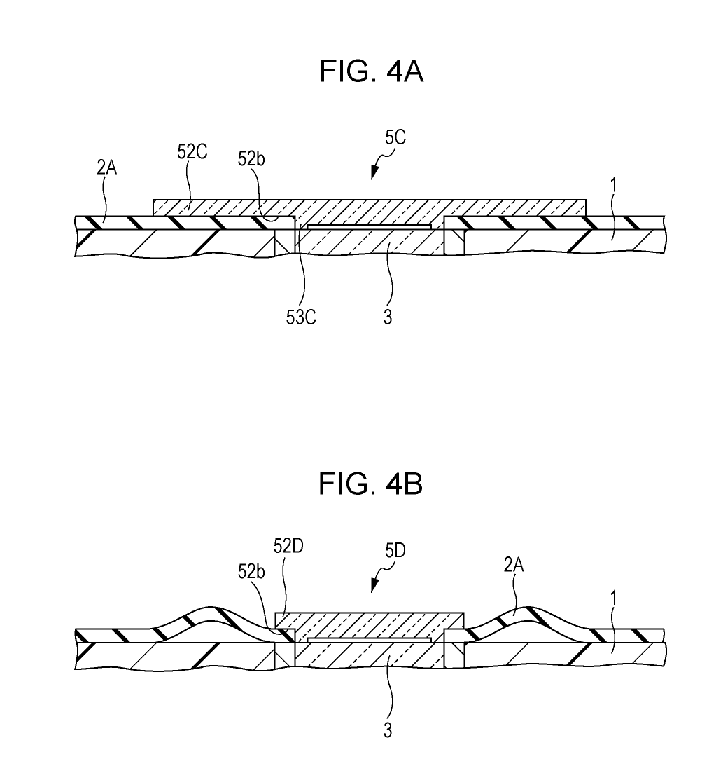

FIG. 4A is a cross-sectional view showing a member provided with a flange-like extending portion.

Referring to FIG. 4A, a member 5C is provided with a flange-like extending portion 52C. The member 5C is bonded to a sheet 2A via a bonding surface 52b of the member 5C.

Referring to FIG. 4A, the member 5C has the extending portion 52C extending beyond the bonding surface 52b. When the member 5C is pressed against the microarray chip 3, the extending portion 52C pushes the sheet 2A, and hence can eliminate an unneeded space in the cartridge.

In contrast, FIG. 4B illustrates a situation without an extending portion. Referring to FIG. 4B, a member 5D does not have an extending portion extending beyond a bonding surface 52b of a bonding portion 52D. In this situation, the member 5D cannot push the sheet 2A. The sheet 2A may be lifted in an area surrounding the member 5D due to the pressure of the content in the cartridge. This may disturb the discharge of the effluent after the hybridization. As described above, if the member 5C has the extending portion 52C (FIG. 4A) that pushes the sheet 2A, the discharge of the effluent after the hybridization can be promoted.

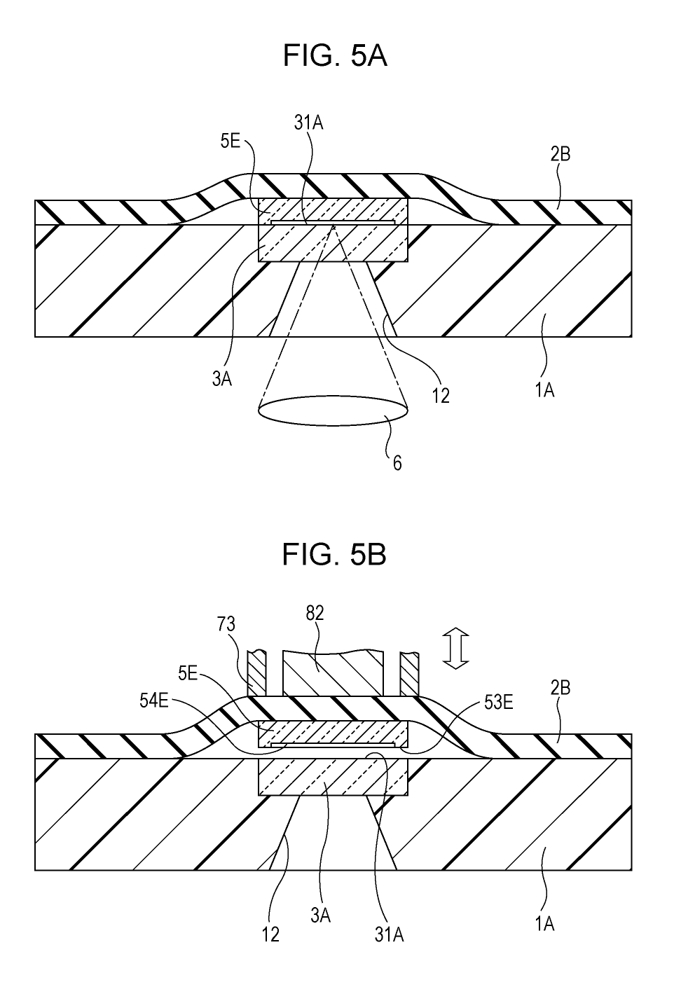

FIGS. 5A and 5B are cross-sectional views showing a cartridge for chemical processing configured to read a microarray chip from a substrate according to another embodiment.

Referring to FIGS. 5A and 5B, this cartridge for chemical processing includes a light-shielding substrate 1A made of a relatively hard resin, and a sheet 2B made of a material, such as a silicone rubber, having an airtight property and elasticity. The sheet 2B is stacked on the substrate 1A.

Referring to FIGS. 5A and 5B, a microarray chip 3A made of a transparent material is attached to the substrate 1A. Sites respectively corresponding to target molecules are arrayed on a surface 31A of the microarray chip 3A. The substrate 1A has a through hole 12 penetrating therethrough from a bottom surface of the substrate 1A (lower surface in FIG. 5A) to the microarray chip 3A.

Also, a light-shielding member 5E is bonded to an inner surface (lower surface in FIG. 5A). The member 5E is made of a material with a higher rigidity than that of the sheet 2B. The member 5E is at a position to face the microarray chip 3A. Referring to FIG. 5B, the member 5E has protrusions 53E that contact the surface 31A of the microarray chip 3A. While the protrusions 53E are in contact with the surface 31A of the microarray chip 3A, the gap between the surface 31A and a bottom surface 54E of the member 5E is maintained uniform.

Referring to FIG. 5B, the member 5E is vibrated by reciprocating suction devices 73 sucking the sheet 2A in the vertical direction in FIG. 5B during hybridization, to stir a hybridization solution or a cleaning solution that is supplied between the microarray chip 3A and the member 5E. Also, at this time, the temperature in the cartridge can be controlled by pressing a thermally conductive member 82 against the member 5E.

After the hybridization, referring to FIG. 5A, the microarray chip 3A is irradiated with laser light through an optical system 6 and fluorescence from the surface 31A is detected while the protrusions 53E of the member 5E are in contact with the surface 31A of the microarray chip 3A. At this time, the microarray chip 3A functions as a window that allows the laser light and fluorescence to pass therethrough and to allow the sites on the microarray chip 3A to be optically read from the outside of the cartridge. The microarray chip 3A may be, for example, a polyolefin resin. The protrusions 53E may be alternatively provided on the surface 31A of the microarray chip 3A.

Also, with the cartridge for chemical processing according to this embodiment, since the gap between the member 5E and the surface 31A of the microarray chip 3A is maintained uniform, nonuniformity caused by the remaining effluent does not appear, and the highly accurate reading can be performed for the entire microarray chip 3A.

Further, with the cartridge for chemical processing according to this embodiment, since the substrate 1A and the member 5E shield light, these light-shielding members reduce background light from the surface of the cartridge and scattered light in the cartridge during the optical reading. Accordingly, the measurement accuracy can be increased.

As described above, with the cartridge for chemical processing according to any of the embodiments and examples of the present invention, a variable range of the gap is restricted such that the width of the entire gap between the surface of the member and the surface of the microarray chip does not become smaller than a predetermined width. Accordingly, the gap between the surface of the member and the surface of the microarray chip can be properly controlled, and the inspection accuracy with the microarray chip can be increased.

The scope and field of application of the present invention is not limited to the embodiments. The present invention can be widely applied to a cartridge for chemical processing, the cartridge carrying out chemical processing while moving a content by deformation based on an externally applied force.

What is claimed is:

1. A cartridge for chemical processing, the cartridge carrying out chemical processing while moving a content by deformation based on an externally applied force, the cartridge comprising:
a microarray chip housed in the cartridge for chemical processing;
a member having a surface that faces a surface of the microarray chip;
supporting means for supporting the member such that a width of a gap between the member and the microarray chip is variable by the externally applied force; and
restricting means for restricting a variable range of the gap by the supporting means such that the width of the entire gap between the surface of the member and the surface of the microarray chip does not become smaller than a predetermined width.

2. The cartridge for chemical processing according to claim 1, wherein the restricting means is provided at the member.

3. The cartridge for chemical processing according to claim 2, wherein the restricting means is formed at the member and serves as a contact portion that contacts the surface of the microarray chip.

4. The cartridge for chemical processing according to any of claims 1 to 3, wherein the gap between the surface of the member and the surface of the microarray chip is uniform when the gap is restricted by the restricting means.

5. The cartridge for chemical processing according to any of claims 1 to 3, wherein the member is transparent and the surface of the microarray chip is optically measurable through the member from the outside of the cartridge for chemical processing.

6. The cartridge for chemical processing according to any of claims 1 to 3, wherein the microarray chip is transparent and the surface of the microarray chip is optically measurable through the microarray chip from the outside of the cartridge for chemical processing.

7. The cartridge for chemical processing according to any of claims 1 to 3, wherein the member has an extending portion that pushes and eliminates a space in the cartridge for chemical processing in an area surrounding the microarray chip when the member is pressed against the microarray chip.

8. The cartridge for chemical processing according to claim 4, wherein the member is transparent and the surface of the microarray chip is optically measurable through the member from the outside of the cartridge for chemical processing.

9. The cartridge for chemical processing according to claim 4, wherein the microarray chip is transparent and the surface of the microarray chip is optically measurable through the microarray chip from the outside of the cartridge for chemical processing.

10. The cartridge for chemical processing according to claim 4, wherein the member has an extending portion that pushes and eliminates a space in the cartridge for chemical processing in an area surrounding the microarray chip when the member is pressed against the microarray chip.

11. The cartridge for chemical processing according to claim 5, wherein the member has an extending portion that pushes and eliminates a space in the cartridge for chemical processing in an area surrounding the microarray chip when the member is pressed against the microarray chip.

12. The cartridge for chemical processing according to claim 6, wherein the member has an extending portion that pushes and eliminates a space in the cartridge for chemical processing in an area surrounding the microarray chip when the member is pressed against the microarray chip.

13. The cartridge for chemical processing according to claim 8, wherein the member has an extending portion that pushes and eliminates a space in the cartridge for chemical processing in an area surrounding the microarray chip when the member is pressed against the microarray chip.

14. The cartridge for chemical processing according to claim 9, wherein the member has an extending portion that pushes and eliminates a space in the cartridge for chemical processing in an area surrounding the microarray chip when the member is pressed against the microarray chip.
